(19) United States
(12) Patent Application Publication
(10) Pub. No.: US 2013/0346043 A1
(43) Pub. Date: Dec. 26, 2013

(54) LOCALIZED MOBILE DECISION SUPPORT METHOD AND SYSTEM FOR ANALYZING AND PERFORMING TRANSPORTATION INFRASTRUCTURE MAINTENANCE ACTIVITIES

(71) Applicant: ITERIS, INC., Santa Ana, CA (US)

(72) Inventors: JOHN J. MEWES, MAYVILLE, ND (US); JEFFREY J. KUNTZ, GRAND FORKS, ND (US)

(21) Appl. No.: 14/013,743

(22) Filed: Aug. 29, 2013

Related U.S. Application Data
(60) Provisional application No. 61/694,775, filed on Aug. 30, 2012.

(51) Int. Cl. G06F 17/50

(52) U.S. Cl. CPC G06F 17/5009
USPC 703/2; 703/6

(57) ABSTRACT

Support for enabling maintenance decision-making activities within a transportation infrastructure network includes one or more methods, apparatuses and systems for localized assimilation, integration, and processing of both locally-generated and remotely-acquired road condition, treatment, and weather data within a mobile computing environment to improve the information available to manage maintenance decisions and performance. This maintenance decision-making support includes communication components and processing modules that integrate data from multiple external sources to locally simulate conditions on, and generate treatment recommendations for, local roadways and transportation network segments based on user-selected parameters.

### CROSS-REFERENCE TO RELATED PATENT APPLICATIONS

This patent application claims priority to U.S. provisional application 61/694,775, filed on Aug. 30, 2012, the contents of which are incorporated in their entirety herein.

### STATEMENT REGARDING FEDERALLY-SPONSORED RESEARCH OR DEVELOPMENT

Not applicable.

### FIELD OF THE INVENTION

The present invention relates generally to transportation infrastructure maintenance. More specifically, particular embodiments of the present invention relate to supporting the information needs of personnel maintaining a roadway network infrastructure through relevant data exchanges and application of decision logic at a localized and/or mobile level.

### BACKGROUND OF THE INVENTION

Transportation agencies employ a wide range of approaches to manage their day-to-day roadway maintenance activities. The approach used depends on a variety of factors, and such is particularly true with winter maintenance activities, where transportation agencies must consider differing environments, traffic profiles, winter maintenance resources, jurisdictional policies and practices, and public expectations. Traditionally, roadway management personnel are kept informed of field activities being carried out by maintenance operators, such as snowplow drivers, via some form of verbal wireless communication, for example mobile radio. Likewise, those same maintenance operators have traditionally been informed and directed from management personnel primarily through that same verbal channel of communication, or simply through direct communication and/or access to other information resources while at the garage facility between discrete winter maintenance activity operations.

Technological advancements have created opportunities for substantial changes to traditional modes of operation within the roadway maintenance industry. This includes the ubiquitous access to cellular and mobile wireless data networks that enable exchanges of data between the maintenance vehicle and servers and/or operations centers remote from the location where maintenance is taking place. These technological advancements have resulted in recent improvements to traditional means of informing highway management personnel that focus on centralized data accumulation, storage, and decision-making, to provide faster and more accurate information for performing field operations. However, such centralized systems of data exchange between maintenance vehicles and servers and/or operations centers remote from the location of field operations may not be able to take real-time changes in conditions or localized infrastructure characteristics into account when instructing field operations personnel.

Therefore, there is a need not found in the current technical art for localized tools that enable specific roadway treatment decisions without requiring receipt of instructions from supervisory operators who are not present at the local roadway and cannot evaluate current scenarios for highly accurate, locally-oriented maintenance activities. The present invention capitalizes on the capabilities of wireless data networks and the power of mobile computing devices to achieve such a need, through a software system capable of assimilating and integrating both local and remote data to provide maintenance operators with improved information to support the management and performance of maintenance activities.

### BRIEF SUMMARY OF THE INVENTION

It is therefore one objective of the present invention to localize the concept of a support system for roadway maintenance decision-making. It is another objective of the present invention to simulate the impact of retrieved weather conditions and other relevant information on local roadways using mobile-based road condition modeling software without having to communicate information to a centralized system and await treatment instructions therefrom. It is a further object of the present invention to integrate data from multiple external sources to simulate conditions on, and generate treatment recommendations to be applied to, local roadways based at least on user-selected parameters to determine an appropriate roadway maintenance response, entirely at a localized level.

The present invention provides systems and methods that operate in a hardware and software computing environment that includes off-the-shelf hardware components, such as laptop personal computers and mobile devices such as smartphones and tablet computers, operating on Windows, Android and iOS operating systems and the like. One or more software-based applications, either installed directly onto these computers and mobile devices or locally accessible therefrom, enable users to retrieve and manipulate information needed to perform the various actions attendant to roadway maintenance decision-making at a localized level. These software-based applications utilize a plurality of modules within the hardware and software computing environment configured to perform customized modeling of road conditions in response to the data ingested, such as weather, observed road conditions, and data from sensors and instruments, and to generate treatment recommendations for winter maintenance activities. The simulated road condition modeling of the present invention is performed at or near the area of the roadway where maintenance treatments may be applied in response to the outcome of the simulations produced by the road condition model.

The present invention utilizes available GPS information representative of mobile device location, whether intrinsically available through device hardware, or through e.g. a USB receiver, to formulate web-based queries for weather information in the vicinity of the mobile device, as well as any remotely-observed road condition data which may be available (such as that coming from Road Weather Information Systems (RWIS)). This information can be pulled by the mobile device at a frequency that is configurable by the user of the system. In certain embodiments, the present invention is also capable of wirelessly receiving, via Bluetooth, USB, or other localized communication method, information from sensors and instruments coupled to maintenance vehicles, including but not limited to instruments such as a spreader controller and plow blade position sensors. Such sensor and instrument data is used to both perform and modulate the simulation of local roadway conditions by the system.

The present invention further includes a user interface that allows users to input and/or adjust data related to key situational and simulation parameters, including road construction and environmental information, as well as average daily traffic (ADT) profiles. The user interface also provides the user with the ability to view a current condition of the roadway resulting from the simulation by the road condition model, and to adjust this condition through the visually-based selection of alternate roadway conditions that better represent the real-time observed conditions. A user-driven adjustment prompts the generation of revised simulations of the roadway condition using the road condition model. One or more icons, pull-down menus, or other indicia may be provided on the user interface to enable the user to perform such actions.

Additionally, users may also specify parameters by which to generate a treatment recommendation for winter maintenance activities on the local roadway. The user may select maintenance configuration information to include a desired condition for the roadway (which may include a visually-based selection), the timeframe over which this desired condition must be maintained, the on-vehicle treatment material(s), such as deicing or abrasive material that the user seeks to apply to the situation, and the range of application rates the user desires to apply. Alternatively, this information may also be queried from preconfigured profiles available on a remote server.

Given this information, and upon either request of the user, the passage of a configurable length of time, or the receipt of a key change to input data, the road condition model may re-generate new simulations of local roadway conditions. Working within the defined maintenance configuration parameters, the present invention may also identify a candidate maintenance activity that will most effectively and efficiently maintain the local roadway given the results of simulations of the response of the roadway to the collective conditions.

Accordingly, one embodiment of the present invention includes a method of managing winter transportation infrastructure maintenance activities for one or more routes of a transportation infrastructure network at a localized level, comprising simulating an impact of route-specific weather data on a local roadway, the route-specific weather data acquired from at least one remote server to a localized maintenance decision support environment proximate to or within a maintenance vehicle configured to perform a maintenance activity, adjusting, using one or more interfaces provided within the localized maintenance decision support environment, one or more simulation parameters to revise the simulated impact of the route-specific weather data on the local roadway, the one or more simulation parameters being adjustable in response to a simulation outcome and real-time weather conditions on the local roadway, the one or more simulation parameters including at least one of maintenance constraints and current conditions experienced on the local roadway, and applying transportation infrastructure network information and maintenance vehicle data to the revised simulation of the impact of route-specific weather data on the local roadway to identify and generate one or more treatment recommendations to maintain the local roadway in response to the revised simulation.

Another embodiment of the present invention provides apparatus for managing winter transportation infrastructure maintenance activities for one or more routes of a transportation infrastructure network at a localized level, comprising a mobile computing platform that includes vehicle-centric hardware and software components forming a localized maintenance decision support environment, proximate to or within a maintenance vehicle configured to perform a maintenance activity relative to a local roadway, and a plurality of modules configured to execute one or more data processing functions that model conditions on the local roadway in response to input data ingested from one or more external sources. The plurality of modules include a road condition model configured for querying route-specific weather data relative to the local roadway and for simulating an impact of the route-specific weather data on the local roadway, and a treatment logic engine configured for identifying one or more treatment recommendations to maintain the local roadway in response to the queried route-specific weather data and simulated impact on the local roadway, transportation infrastructure network information ingested from one or more agency-specific servers, and maintenance vehicle data ingested from one or more maintenance vehicles capable of providing treatments to the local roadway. The road condition model is further configured to generate one or more simulations in response to one or more simulation parameters representative of at least one of maintenance constraints and current conditions experienced on the local roadway, and one or more treatment recommendations to maintain the local roadway, following any one of a user request, a passage of a configurable length of time, or reception of a specific change of input data. The apparatus also provides a touchscreen user interface enabling presentation of output data to a user of the mobile computing platform and input of the one or more simulation parameters entered by the user.

A further embodiment of the present invention discloses method of localized analysis of roadway conditions for managing winter transportation infrastructure maintenance activities on a roadway network, comprising integrating input data representative of weather and maintenance conditions for a local roadway into a plurality of data processing functions performed by one or modules in a localized maintenance decision support environment, and modeling a road condition response to the input data representative of weather and maintenance conditions on a local roadway. The plurality of data processing functions are configured at least to simulate an impact of route-specific weather data on a local roadway, evaluate an outcome of the simulated impact of route-specific weather data on the local roadway and apply one or more simulation parameters to revise a simulation of the impact of the route-specific weather data on the local roadway, the one or more simulation parameters being adjustable in response to the outcome of the simulated impact and real-time weather conditions on the local roadway, the one or more simulation parameters including at least one of maintenance constraints and current conditions experienced in real-time on the local roadway, adjust the simulated impact of route-specific weather data on the local roadway based upon the one or more simulation parameters by performing additional simulations, and apply transportation infrastructure network information and maintenance vehicle data to the additional simulations of the impact of route-specific weather data on the local roadway. This method also discloses generating output data that at least includes an identification of one or more treatment recommendations for the local roadway, and presenting the output data on a user interface to enable a determination of an appropriate maintenance response to the additional simulations and the one or more treatment recommendations.

To further support the information requirements of the user, an embodiment of the present invention permits both GPS- and favorites-based based collection of photographic and video imagery from available cameras and Road Weather Information System (RWIS) Environmental Sensing Stations (ESS), as well as other data sources. Thumbnail imagery from these cameras is then automatically provided to the user in a dashboard screen, which also includes summary information including weather conditions, road conditions, ongoing and/or historical maintenance activities, and/or the user's location. In still another embodiment, the present invention acts as a local data assimilation and integration system. It is therefore able to store the data it collects and/or generates and re-transmit data to a configurable server via the same cellular or mobile data network through which it is receiving weather data and photo and video imagery.

Other objectives, embodiments, features and advantages of the present invention will become apparent from the following description of the embodiments, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a block diagram of a localized, vehicle-centric weather-based roadway maintenance decision support system according to the present invention;

FIG. 2 is an exemplary screenshot of a mobile touchscreen interface according to one aspect of the present invention;

FIG. 3 is exemplary popped-out window in a screenshot of images of current road conditions selectable from the mobile touchscreen interface of FIG. 2, which are further selectable by a user according to one aspect of the present invention;

FIG. 4 is an exemplary popped-out window in a screenshot of load characteristics of a winter maintenance vehicle which is selectable from the mobile touchscreen interface of FIG. 2, showing details of vehicular loads according to one aspect of the present invention; and

FIG. 5 is exemplary popped-out window in a screenshot of user-modifiable maintenance assumptions, selectable from the mobile touchscreen interface of FIG. 2, for various aspects of winter maintenance activities according to one aspect of the present invention.

### DETAILED DESCRIPTION OF THE INVENTION

In the following description of the present invention reference is made to the accompanying figures which form a part thereof, and in which is shown, by way of illustration, exemplary embodiments illustrating the principles of the present invention and how it is practiced. Other embodiments will be utilized to practice the present invention and structural and functional changes will be made thereto without departing from the scope of the present invention.

The present invention discloses a localized, vehicle-centric, weather-based roadway maintenance decision support environment 100 in a system and method that allows a user to perform customized road condition modeling of local roadways based on real-time weather conditions, and other data including information from maintenance equipment, data from various sensors affixed to or otherwise configured to monitor the roadway, and operator input. The customized road condition model of the present invention enables users to perform simulations of the impact of various selected parameters on such road condition modeling, and further enables generation of treatment recommendations for winter maintenance activities on local roadways. The present invention operates in a mobile computing environment that performs these functions without having to communicate information to a centralized system and await treatment instructions therefrom.

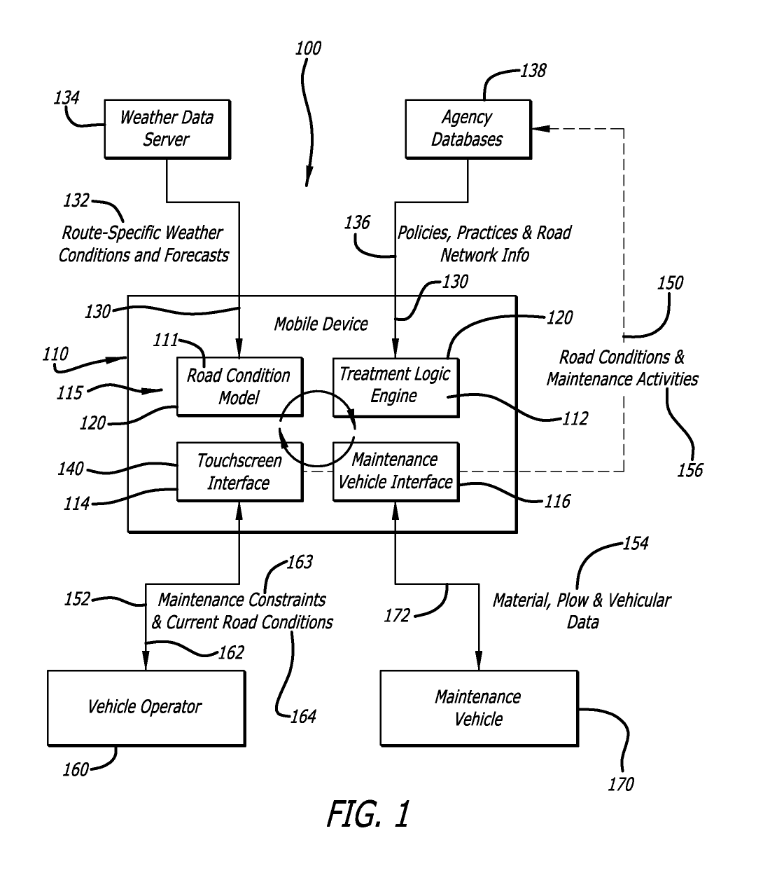

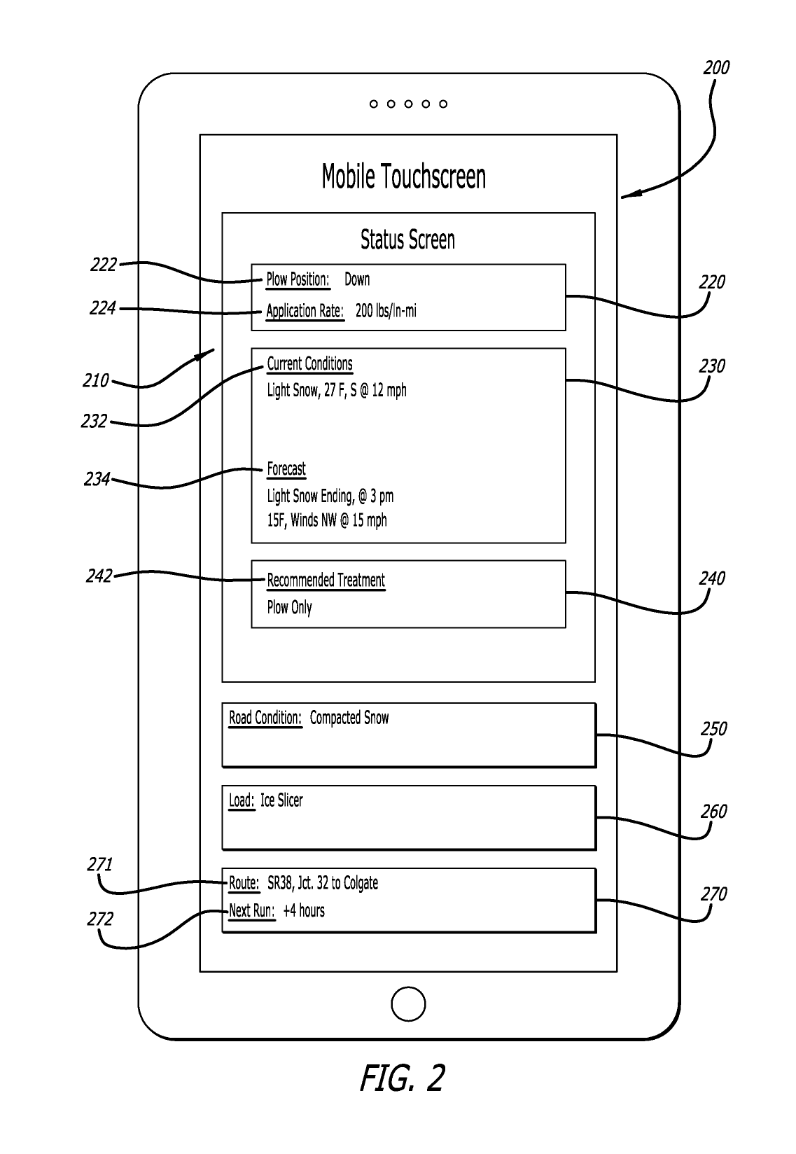

FIG. 1 is block diagram of such a localized, vehicle-centric weather-based roadway maintenance decision support environment 100 according to the present invention. Customized road condition modeling within the present invention is performed on a localized, mobile computing platform 110 on which one or more data processing modules 120 are configured to ingest a plurality of input data 130 from multiple sources. User-selectable parameters for the customized road condition modeling are enabled via one or more interfaces 140, shown in further exemplary detail in FIGS. 2-5, as noted further below. Output data 150 is generated by the one or more data processing modules 120 on the localized, mobile computing platform 110 for use at least by a vehicle operator 160 and by a maintenance vehicle 170.

The input data 130 ingested into the localized, vehicle-centric weather-based roadway maintenance decision support environment 100 at least includes route-specific weather conditions and forecasts 132 from at least one weather data server 134, and transportation infrastructure network information 136, including local maintenance policies and practices, from one or more agency databases 138. The at least one weather data server 134, and the one or more agency databases 138, as well as other external sources of input data 130, provide information for the localized, mobile computing platform 110, which communicates with these external sources either automatically or at the specific request of a user or data processing module 120 for processing of the input data 130. Accordingly, the present invention also includes one or more communications links 180, not shown in FIG. 1, that are utilized by the localized, mobile computing platform 110 to transmit requests for such input data 130, and to receive such input data 130 therefrom, either automatically or in response to such a transmitted request.

The at least one weather data server 134 may include any system or component capable of storing weather information and/or generating meteorological forecasts for a specific segment, link, or route forming part of a transportation infrastructure network for which the localized, vehicle-centric weather-based roadway maintenance decision support environment 100 is to be utilized to perform customized road condition modeling according to the present invention. Many different sources of weather data may provide the route-specific weather conditions and forecasts 132 and may be coupled to the at least one weather data server 134. The different sources of weather data may include data from both in-situ and remotely-sensed observation platforms. For example, weather station data may be combined data from weather radars, satellites, and computer models to reconstruct the current weather conditions on any particular link or segment of road.

Such different sources of weather data may further include data representative of a plurality of weather variables, and these variables may be embodied in data feeds generated from numerical weather prediction (NWP) models. There are numerous industry NWP models available, and any such models may be used to input weather variables in the present invention via the at least one weather data server 134. NWP models used herein at least include RUC (Rapid Update Cycle), WRF (Weather Research and Forecasting Model), GFS (Global Forecast System), and GEM (Global Environmental Model). This weather data is received in real-time, and may come from several different NWP sources, such as from Meteorological Services of Canada (MSC) and the Canadian Meteorological Centre (CMC), as well as the National Oceanic and Atmospheric Administration's (NOAA) Environmental Modeling Center (EMC), and many others. Additionally, internally or privately-generated “mesoscale” NWP models developed from data collected from real-time feeds to global observation resources may also be utilized. Such mesoscale numerical weather prediction models may be specialized in forecasting weather with more local detail than the models operated at government centers, and therefore contain smaller-scale data collections than other NWP models used. These mesoscale models are very useful in characterizing how weather conditions may vary over small distances and over small increments of time. The present invention may be configured to ingest data from all types of NWP models, regardless of whether publicly, privately, or internally provided or developed.

The route-specific weather conditions and forecasts 132 may therefore comprise sets of data representative of many different variables that convey information about weather conditions experienced over a specific period of time for a route of a transportation infrastructure network to be modeled by the present invention. These sets of data may include historical, real-time, or forecasted conditions, and the different variables may convey attributes such as for example precipitation type and amount, wind speed and direction, an atmospheric profile representative of different meteorological characteristics such as barometric pressure and humidity, and any other information which may be useful in performing customized road condition modeling as contemplated herein.

The route-specific weather conditions and forecasts 132 may further comprise weather information provided by sources separate from those generating NWP model data as noted above. For example, the weather data server 134 may be configured to collect weather data from non-traditional sources of information such as for example from crowd-sourced observations, social media feeds, and other vehicles on or near the route to be modeled. Information from crowd-sourced observations and social media feeds may be generated by one or more users entering such information relative to the route of the transportation infrastructure network to be modeled, for example via mobile applications on tablets or telephony devices, and may occur in real-time or near real-time to reflect the most current conditions being experienced on the specific route to be modeled. In the case of data collected from other vehicles on or near the route to be modeled, the weather data server 134 may be coupled to components configured, in a further example, to either query or passively collect data from such vehicles, such as data from mobile telephony devices, signal strength of Bluetooth devices, and any other means of determining weather data on a route from vehicles using that route.

The transportation infrastructure network information 136 may include road network information that enables accurate modeling of roadway conditions, such as for example localized route or street maps of the area for which the present invention is being utilized, and/or roadway construction and/or information regarding the characteristics of the ambient environment. This transportation infrastructure network information 136 may also include different types of vehicular data for the roadway to be modeled, such as historical and real-time traffic conditions, speed data, vehicular positional information such as that generated by Global Positioning System (GPS) devices, and any other such data, either raw or processed, which may impact modeling of treatment conditions on the transportation infrastructure network.

This transportation infrastructure network information 136 further comprises information on local maintenance policies and practices, which may differ greatly from jurisdiction to jurisdiction based on a variety of factors. For example, within a particular state, each county or municipality may have different contractual arrangements for provision of treatment materials, may have different types and sizes of fleets of maintenance vehicles provided by different manufacturers, and may have different approaches to maintenance activities based on needs and preferences of the local users of the roadways to be modeled. Accordingly, the local maintenance policies and practices may have significant impact on the outcome of the customized road condition modeling discussed herein.

The one or more data processing modules 120 configured on the localized, mobile computing platform 110 at least include a road condition model 111 and a treatment logic engine 112. They also include modules for providing one or more interfaces 140, which include a touchscreen interface 114 for communicating with one or more vehicle operators 160 via a graphical user interface on a mobile device 115, and a separate maintenance vehicle interface 116 that permits the mobile device 115 to communicate with a maintenance vehicle 170.

The touchscreen interface 114 on the mobile device 115 enables a vehicle operator 160 to input additional information 162 to the localized, mobile computing platform 110, such additional information including maintenance constraints 163 and current road conditions 164. Vehicle operators 160 themselves provide this information to the localized, mobile computing platform 110 via the touchscreen interface 114, enabling the present invention to perform customized road condition modeling of local roadways using real-time data experienced by and/or generated by vehicle operators 160. For example, maintenance constraints of vehicles in operation may be a factor in modeling road conditions, such as the condition of various mechanical parts of the vehicle, the immediate availability of treatment materials, the need for re-fueling, etc. Similarly, real-time, localized weather and road conditions may be entered by the vehicle operators 160, which may have a further impact on the outcome of road condition modeling. For example, vehicle operators noting real-time changes in wind-speed, temperature, precipitation, and non-weather factors such as obstacles in the roadway itself may be data provided by vehicle operators which could have a material impact on the simulated outcomes of the customized road condition modeling performed by the present invention.

Similarly, the maintenance vehicle interface 116 enables additional information 172, representative of data collected and/or sensed by a maintenance vehicle 170, to be provided as additional input to the localized, mobile computing platform 110 for customized modeling of roadway maintenance activities. Such additional information 172 includes materials data 173, plow data 174, and vehicular data 175. For example, the sensors coupled to maintenance vehicles 170 may collect and transmit information about roadway conditions and weather conditions to the localized, mobile computing platform. The vehicle itself may transmit data relative to the availability of treatment materials, and about its own maintenance condition, such as mechanical issues experienced by components of the vehicle, amount of remaining fuel, etc. The additional information 172 may also include more sophisticated analytical data such as the real-time effects of particular applications of maintenance treatments, the real-time effects of particular plow or component activity, and projected remaining distance-to-empty relative to fuel amount, given current speed, activity, and weather conditions. It is therefore to be understood that both the vehicle operators 160 and the maintenance vehicles 170 may contribute real-time data to the localized, mobile computing platform that may influence output data generated by the present invention.

The output data 150 of the customized road condition modeling performed by the localized, mobile computing platform 110 may include several types of information that enables vehicle operators 160, maintenance vehicles 170, and agencies to conduct and plan winter maintenance activities, and similar information to that described above as additional information 162 and 172 may be provided back to vehicle operators 160 and maintenance vehicles 170. For example, output data 150 may include information 152 on maintenance constraints and current road conditions communicated to vehicle operators 160, and may include instructions 154 on material treatments, plow usage, and vehicular operation communicated to maintenance vehicles 170 themselves.

The maintenance vehicle interface 116 also enables communication of output data 150, such as road conditions and maintenance activities 156, to the one or more agency databases 138. This component of the output data 150 is then maintained in such databases and may be used for a variety of purposes, such as for example recording treatments performed on the roadway network for later use by the agency to which it is communicated, for providing future input data for the localized, mobile computing platform 110, for additional modeling of future maintenance and/or construction activity (such as in non-winter months, for further example), and any other usage of such data which may assist agencies tasked with maintaining roadway networks.

The one or more agency databases 138 may therefore comprise data storage components maintained by or managed by any public or private agency or other entity responsible for maintaining and/or operating a transportation infrastructure network. For example, such a database 138 may be part of a particular state's Department of Transportation, which is responsible for roadway networks in that state. Private entities may also be recipients of output data 150 communicated to agency databases 138, such as companies that contract or sub-contract with such transportation departments. Such agency databases 138 may also be connected with centralized maintenance decision support systems which conduct additional data analytics for other types of vehicle information systems.

Users of the present invention may include vehicle operators 160, such as the drivers of roadway maintenance vehicles, and supervisory personnel at or near a roadway to be treated with maintenance actions. Regardless, while it is contemplated that users of the present invention will be in or near maintenance vehicles, they need not be physically present inside a maintenance vehicle for the present invention to be operable.

The present invention is performed in a hardware and software computing environment that includes a mobile system in which as least part of the localized, mobile computing platform 110 of the present invention is operated, and may include one or more of a laptop or other mobile computing devices, such as a tablet, personal digital assistant, smart time-keeping device, or smartphone. As noted above, users may operate these computing devices locally at or near a roadway to be analyzed, such as for example in or near a vehicle on the roadway to be analyzed, including maintenance vehicles such as snowplows. Each device in such a hardware and software computing environment according to the present invention may be capable of communicating with multiple information resources, and include software capable of such communications as well as for performing the road condition modeling, simulation, visually-based observation of roadway conditions, and entry of customized data parameters that are described in detail herein.

The information resources with which a mobile computing device communicates in the present invention may, as noted above, include sensors and other instruments. These sensors and instruments may be coupled to maintenance vehicles, but may also include sensors and instruments embedded in or positioned near the roadway that is to be analyzed. Information resources may further include web-based requests for weather information, and photo and video imagery taken by cameras positioned at or near a roadway. They may further include numerical data, and observations and thoughts, entered by the user, and may further include data entered by other users in the vicinity of the roadway to be treated, such as for example other nearby operators of snow maintenance vehicles. Information resources may be queried at a user's request, or at periodic times, at either pre-set frequencies or those set by the user, to acquire data for processing and simulation by the present invention. Each mobile computing device may be pre-loaded with software that provides a user interface from which to perform the simulation of road conditions and generate treatment recommendations of the present invention. The user interface may include multiple pull-down menus and other objects, such as icons and other indicia, from which users may select various functions to be performed, including data collection, simulations, and generation of treatment recommendations. The plurality of data processing software modules 120 are resident at the mobile computing device and available to the user to perform the simulations by the road condition model, view current conditions on the roadway, adjust simulations based upon current and forecasted conditions, request and manipulate specific data as needed, select various parameters (either pre-provided, generated by the data concerning the roadway, or specified by the user) and generate suggested maintenance activities.

The present invention is therefore configured to provide the user with localized tools that enable specific roadway treatment decisions without a requirement to receive instructions from supervisory operations not present at the local roadway. The user interface and device-level data processing modules, and all of the information available to the computing device and user of the present invention, allow for either simulation of road condition models, maintenance decision-making, or both, at a localized level. The present invention therefor enables real-time, mobile, and roadway-specific decision-making ability and responsiveness to those responsible for maintaining and treating roadways.

The present invention, as noted above, models simulated road conditions in response to the ingested input data 130 and generates treatment recommendations for winter maintenance activities on local roadways, from the localized, mobile computing platform 110. The modeling of simulated road conditions and generation of treatment recommendations is performed by the one or more data processing modules 120, which are configured at the localized, mobile computing platform 110, so that information does not have to be communicated to and from a centralized server, and so that the functions performed by the present invention are carried out at the mobile level to provide the treatment recommendations that are accurately reflective of conditions experienced by vehicle operators 160 and the maintenance vehicles 170.

One such data processing module 120 is the road condition model 111, which is a framework for analyzing and forecasting roadway conditions, such as pavement characteristics, to simulate the impact of maintenance activities on the roadway. This is accomplished by modeling various treatment paradigms and weather attributes for the section of roadway being treated. In one or more further embodiments, the road condition model 111 may further apply estimates of traffic characteristics such as speed, flow, and incidents to analyze and model traffic conditions on the roadway in order to further improve the quality and accuracy of maintenance treatment recommendations.

One embodiment of the present invention provides a road condition model 111 that forecasts road conditions by analyzing mass and energy balances of moisture atop the roadway resulting from a roadway's response to treatments to be applied. This is performed using an equation of unsteady heat flow, combined with sophisticated parameterizations for representing heat and moisture exchanges between the road, the atmosphere, and pavement substrate, in view of weather conditions and attributes of the treatments being applied. Balance between mass and energy, particularly in a pavement surface condition context, means that changes in the state of moisture occur only as energy flows permit, so that for example, evaporating moisture away from the road surface requires energy from the road surface, which cools it. Dew or frost formation have the opposite effect of putting energy into the pavement. Perhaps more important, however, are changes between liquid and solid states of moisture. For example, in order for a road that has ice on it to warm above freezing, or vice-versa, the latent heat of fusion must be overcome. This normally causes the road temperature to stabilize at the freeze point temperature while this phase transition occurs. This also means that when moisture (as snow, rain, frost, dew) is deposited onto the road it also transfers energy to or from the road, and that evaporation or sublimation of moisture from the road requires the road to have an adequate amount of energy available to support those processes. Materials applied to the roadway surface have a further definitive impact on these energy transfers, depending at least upon their type and quantity.

These energy transfers have a profound effect on roadway conditions, particularly as it pertains to the response of the roadway to maintenance activities performed. One methodology for capitalizing on distinctions between mass and energy balance in the present invention is from the fact that the freeze point of water can be reduced by adding certain chemicals to a treatment mixture to be applied to a roadway, such as for example salt. In this embodiment, the road condition model 111 may partition the moisture atop the pavement surface into categories representing different possible forms that moisture can take (e.g., liquid, snow, ice, frost, compacted snow, etc.), and then uses the eutectic properties of any chemicals that are added to the mix to repartition the moisture between these categories. In this repartitioning process, mass and energy balance are maintained, since when salt is applied to a road with frozen moisture on it, the road temperature will typically undergo a rapid drop, followed by a slower recovery. This occurs because the energy required to melt the ice is coming from the pavement, and all the salt has done is change the temperature where equilibrium exists (i.e., where there is no tendency for energy to flow from the road to the ice, or vice-versa).

As time passes, energy will normally be drawn upward from lower in the roadbed either in or beneath the pavement substrate, permitting the road to warm back up to near its original temperature again. This permits the road condition model 111 to simulate the simultaneous impacts of multiple deicers, each with differing properties. The mixing of chemicals requires an iterative approach to finding where the equilibrium state lies, and therefore a localized approach that incorporates the various input data 130 described herein into the road condition model 111 to find this equilibrium state, at the localized, mobile level as contemplated by the present invention, provides a significant advantage over existing systems and methods by permitting ingest of localized information relative to real-time conditions experienced at the treatment site.

The importance of this ability to appropriately manage the partitioning of moisture into its different forms is that it directly influences how the application of various treatments will impact the road condition, particularly as it responds to traffic usage of the roadway after application. With sufficient liquid moisture present, vehicles using the roadway in traffic act to splatter or spray the entire mixture off of the road surface. As the amount of liquid in the mixture decreases, transitions in this behavior occur, first to a consistency where the moisture atop the road is simply moved short lateral distances with the passage of each successive vehicle, and eventually to a consistency where the mixture is increasingly taken under the tires of each successive vehicle where it can be compacted into a more hardened form that is both difficult to travel upon and difficult to remove. Winter maintenance activities often seek to maintain sufficient liquid in this mixture so as to prevent this deterioration.

The present invention may therefore incorporate, as noted above, the impact of traffic in response to maintenance treatments applied to a roadway. In this manner, the transportation infrastructure network information 136 ingested into the localized, mobile computing platform 110 may include traffic data as noted above. Regardless, however, the road condition model 111 of the present invention is configured to model simulations of roadway responses to treatment paradigms and weather conditions, irrespective of what type of traffic conditions may be later experienced.

The road condition model 111 ingests the route-specific weather conditions and forecasts 132, and simulates road conditions using this information together with the impact of treatment paradigms on roadway conditions, which are performed by the treatment logic engine 112. The treatment logic engine 112 is comprised of a plurality of decision logic components configured to perform mathematical functions that utilize the simulations described above performed by the road condition model 111 to generate treatment recommendations for winter maintenance activities. The treatment engine logic 112 ingests the transportation infrastructure network information 136, which includes the road network information that enables accurate modeling of roadway conditions, as well as the local maintenance policies and practices, which as noted above may differ greatly from jurisdiction to jurisdiction based on a variety of factors. This transportation infrastructure network information 136 influences the recommendation of treatments applied to the roadway as described above within the road condition model 111.

Together, the road condition model 111 and the treatment engine logic 112 apply the weather information and road network information, together with data specific to road conditions and maintenance activities 156 being performed and with data provided by vehicle operators 160 and maintenance vehicles 170, to produce the simulations and treatment recommendations comprising the output data 150 of the localized, mobile computing platform 110 of the present invention.

FIG. 2 is an exemplary screenshot of a touchscreen interface 114 configured for a mobile device 115 according to one aspect of the present invention. The touchscreen interface 114 shows a mobile touchscreen 200 that may include indicia in the form of text boxes, as shown in FIG. 2, which provide details relative to the maintenance treatment recommendations generated by the road condition model 111 and treatment logic engine 112 performed within the localized, vehicle-centric weather-based roadway maintenance decision support environment 100. The indicia may include a “Status Screen” section 210, which provides details such as vehicle status section 220, a weather conditions section 230, and a recommended treatment section 240. The vehicle status section 220 may show information such as plow position 222 and a treatment application rate 224, and the weather conditions section 230 may show information such as current conditions 232 and forecast 234. The recommended treatment section 240 indicates to the user the one or more treatment recommendations 242 generated as the output of the treatment engine logic 112, in view of the simulation outcomes generated by the road condition model 111.

The mobile touchscreen 200 may also include a road condition section 250, showing the current condition of the road relative to the weather, a load section 260 that shows what treatment materials that a maintenance vehicle has been loaded with, and a route section 270 showing the current route 271 being followed by the maintenance vehicle. The mobile touchscreen 200 may also indicate a time for a next run 272.

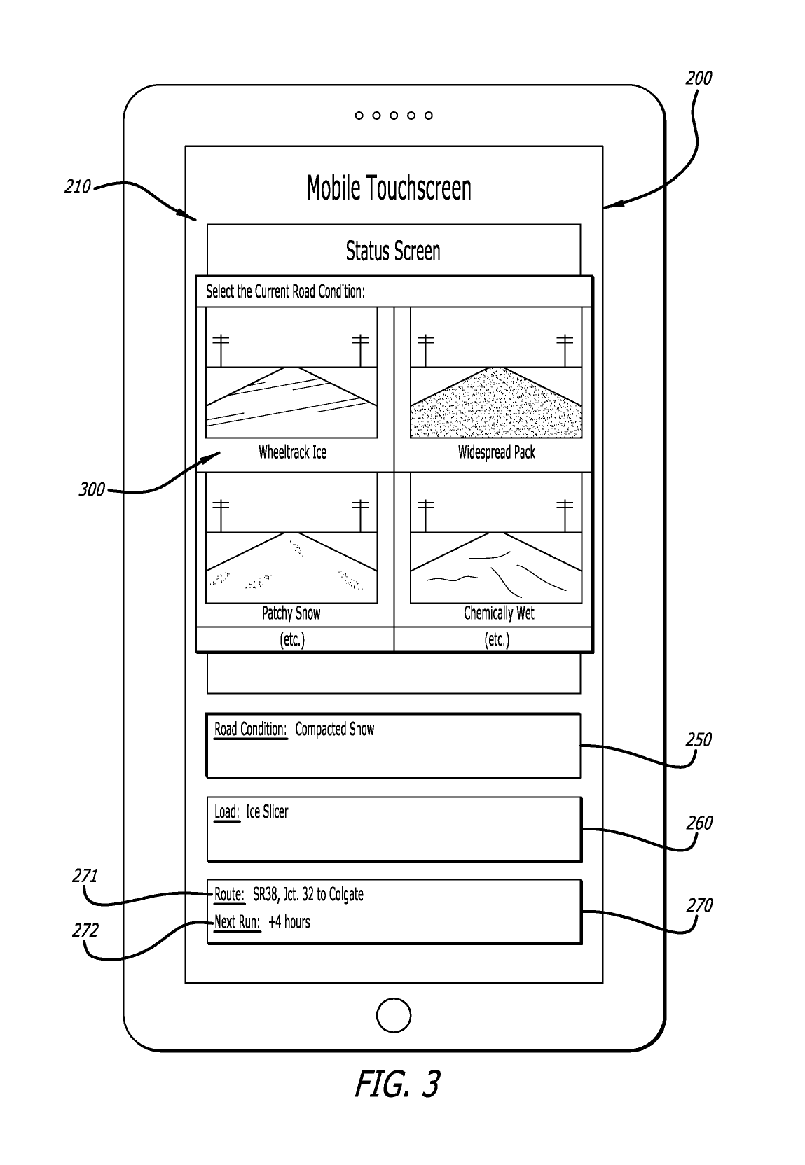

Users of the present invention are capable of adjusting or changing at least some of the information present in the mobile touchscreen 200 by selecting the indicia shown thereon. For example, FIG. 3 is exemplary screenshot of images of current road conditions selectable from the mobile touchscreen 200 of FIG. 2. When a user selects this indicia 250, the window 300 shown in FIG. 3 appears on the touchscreen interface 114, which provides additional conditions that are further selectable by a user in one aspect of the present invention. For example, though the exemplary screenshot of FIG. 2 shows a road condition 250 as “compacted snow” a user may select the road condition indicia 250 and then select from additional conditions as shown in FIG. 3.

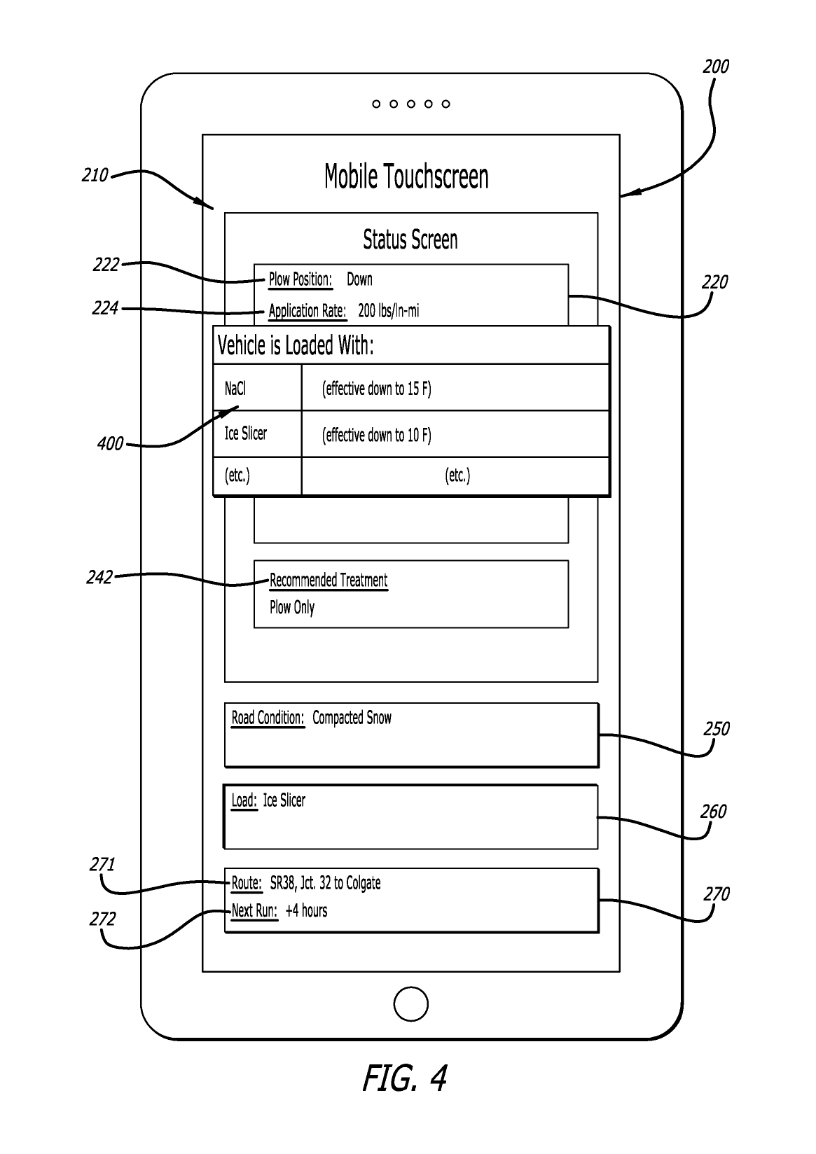

FIG. 4 is an additional exemplary screenshot of information that users may adjust or change with the mobile touchscreen 200. In FIG. 4, different load characteristics relative to treatments that can be provided by a winter maintenance vehicle are selectable via the window 400. FIG. 4 shows details of particular materials that a vehicle may be loaded with according to one aspect of the present invention. While the window 400 indicates two different materials, many other materials may be shown, and therefore many more may be shown as being available materials for selection. FIG. 4 also indicates, as noted above, that vehicle operators 160 may apply user-provided data to the road condition modeling and simulation performed by the present invention, so that vehicle operators 160 may indicate, via the touchscreen interface 114 and mobile touchscreen 200, that only an Ice Slicer or NaCl (or both) are available materials, using the example of FIG. 4. In this manner, the present invention is therefore configured to provide accurate treatment recommendations 242 at the localized level without having to communicate with a centralized server for any information, since the vehicle operators 160 have themselves provided the most accurate materials availability information for the present invention to be performed.

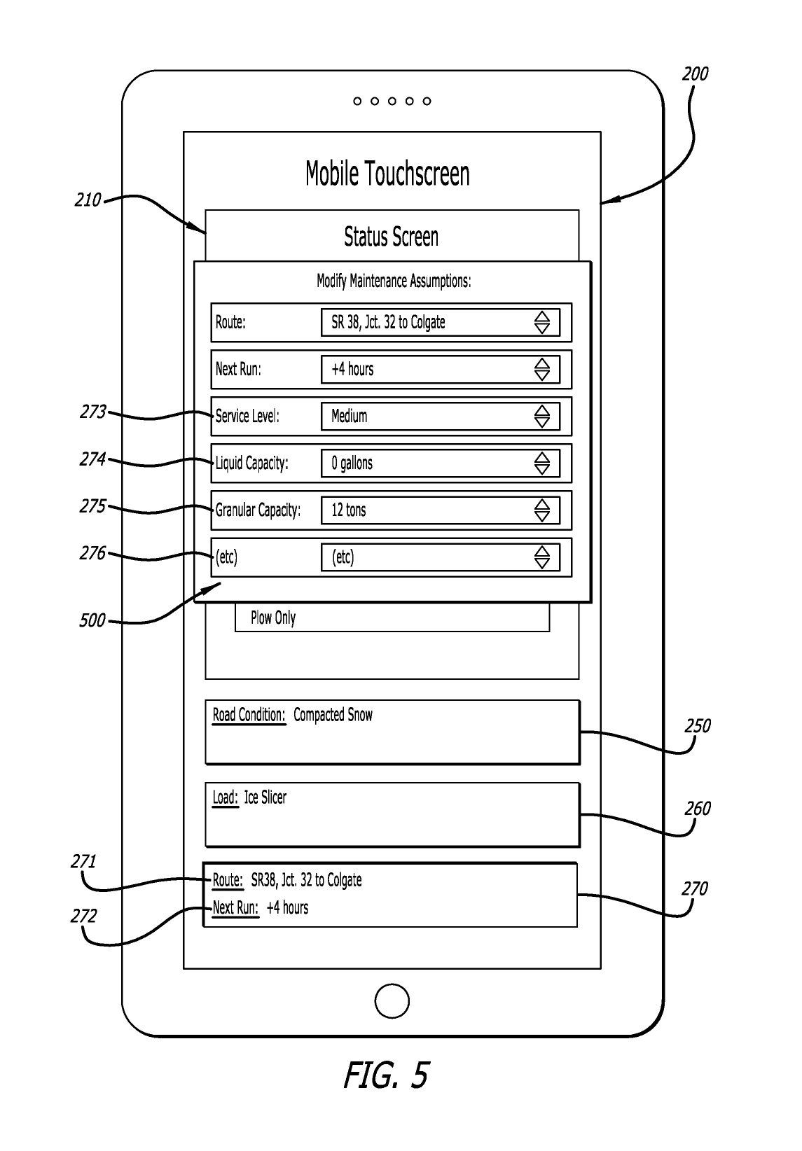

FIG. 5 is a further exemplary screenshot of information that users may adjust or change with the mobile touchscreen 200. FIG. 5 shows a window 500 of user-modifiable maintenance assumptions 510, selectable as noted above from the mobile touchscreen interface of FIG. 2, for various aspects of winter maintenance activities. The user may therefore provide input on a variety of different maintenance attributes, such as for example the route 271 being followed by the maintenance vehicle, a time for a next run 272, a service level 273, a liquid capacity 274, a granular capacity 275, and other information 276 which may comprise any conceivable type of data which could impact the output data generated by the present invention. Indicia in the form of up and down arrows may be provided within each section of FIG. 5 (as well as in other selectable windows 300 and 400 as in FIG. 3 and FIG. 4) to allow the user to select from available choices, and the user may additionally be able to enter text directly into text boxes themselves in each popup section.

The systems and methods of the localized, vehicle-centric weather-based roadway maintenance decision support environment 100 of the present invention may be further implemented in conjunction with many different hardware components, such as a special purpose computer, a programmed microprocessor or microcontroller and peripheral integrated circuit element(s), an ASIC or other integrated circuit, a digital signal processor, electronic and/or digital logic circuitry, a programmable logic device or gate array such as a PLD, PLA, FPGA, PAL, and any other comparable components. In general, any means of implementing the systems and methods illustrated herein may be used to implement the various embodiments and aspects of the present invention. Examples of devices that can be used for the present invention includes computers, handheld devices, telephony-enabled devices (e.g., cellular, Internet enabled, digital, analog, hybrids, and others), and other such hardware components, machines, and apparatuses. These may include processors (e.g., a single or multiple microprocessors), memory, nonvolatile storage, and other peripheral input devices, and output devices. Furthermore, alternative software implementations including, but not limited to, neural networks, distributed processing, parallel processing, or virtual machine processing can also be configured to perform the methods described herein.

The systems and methods of the present invention may also be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on personal computer, as a resource residing on a server or computer workstation, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed, as noted above, by one or more modules configured to carry out those program instructions. Modules are intended to refer to any known or later developed hardware, software, firmware, artificial intelligence, fuzzy logic, expert system or combination of hardware and software that is capable of performing the data processing functionality described herein.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. For example, one or more users or operators may form a sub-network to coordinate localized treatments in the same vicinity, and the present invention may be configured to enable input of crowd-sourced observations by members of the sub-network so that data from maintenance personnel in a common local area may be combined. For further example, traffic speed data generated by a traffic speed estimation model may also be ingested as input data 130 into the road condition model 111 and treatment logic engine 112. It is therefore intended that the scope of the invention be limited not by this detailed description.

1. A method of managing maintenance activities for one or more routes of a transportation infrastructure network at a localized level, comprising:
simulating an impact of route-specific weather data on a local roadway, the route-specific weather data acquired from at least one remote server to a localized maintenance decision support environment that is proximate to or within a maintenance vehicle configured to perform a maintenance activity;
adjusting one or more simulation parameters to revise the simulated impact of the route-specific weather data on the local roadway, the one or more simulation parameters being user-adjustable in response to a simulation outcome and real-time road or weather conditions on the local roadway, the one or more simulation parameters including at least one of maintenance constraints and current conditions experienced on the local roadway; and
applying transportation infrastructure network information and maintenance vehicle data to revise the simulation of the impact of route-specific weather data on the local roadway to identify and generate one or more treatment recommendations to maintain the local roadway in response to the revised simulation.

2. The method of claim 1, wherein the localized maintenance decision support environment is substantially embodied on a mobile computing platform that includes vehicle-centric hardware and software components configured to execute one or more program instructions to perform the simulating an impact of route-specific weather data on a local roadway, adjusting one or more simulation parameters to revise simulated impact of the route-specific weather data on the local roadway, and applying transportation infrastructure network information and maintenance vehicle data.

3. The method of claim 2, wherein the transportation infrastructure network information includes maintenance policies, localized practices, and road network information relative to maintenance activities to be performed on the local roadway, and wherein the road network information includes one or more of road construction data, environmental variables, and traffic profiles.

4. The method of claim 2, wherein the maintenance vehicle data includes data regarding material treatments applied or to be applied, plow usage, and vehicular operation.

5. The method of claim 2, wherein the identifying and generating one or more treatment recommendations to maintain the local roadway in response to the revised simulation occurs following any one of a user request, a passage of a configurable length of time, or reception of a specific change of input data.

6. The method of claim 2, further comprising enabling a user to view a current condition of the local roadway resulting from the simulated impact of route-specific weather data on a local roadway, and adjust the current condition through a selection of alternate roadway conditions that are representative of real-time observed conditions, using one or more interfaces provided within the localized maintenance decision support environment.

7. The method of claim 2, further comprising enabling a user to select at least one of maintenance configuration information reflecting a desired condition for the local roadway, a timeframe over which the desired condition for the local roadway is to be maintained, the on-vehicle treatment materials to be applied to achieve the desired condition for the local roadway, and the range of application rates of the on-vehicle treatment materials to be applied, using one or more interfaces provided within the localized maintenance decision support environment.

8. The method of claim 7, further comprising querying at least one of the maintenance configuration information, timeframe, on-vehicle treatment materials to be applied, and the range of application rates from preconfigured profiles available on a remote server.

9. The method of claim 2, further comprising communicating a current condition of the local roadway resulting from the simulated impact of route-specific weather data on a local roadway, and maintenance activities performed in response to the one or more treatment recommendations, to an agency database.

10. An apparatus for managing maintenance activities for one or more routes of a transportation infrastructure network at a localized level, comprising:
a mobile computing platform that includes vehicle-centric hardware and software components forming a localized maintenance decision support environment, proximate to or within a maintenance vehicle configured to perform or direct a maintenance activity relative to a local roadway;
a plurality of modules configured to execute one or more data processing functions that model conditions on the local roadway in response to input data ingested from one or more external sources, the plurality of modules including:
a road condition model configured for querying route-specific weather data relative to the local roadway and for simulating an impact of the route-specific weather data on the local roadway, and
a treatment logic engine configured for identifying one or more treatment recommendations to maintain the local roadway in response to the queried route-specific weather data and simulated impact on the local roadway, transportation infrastructure network information ingested from one or more agency-specific servers, and maintenance vehicle data ingested from one or more maintenance vehicles capable of providing treatments to the local roadway,
wherein
the road condition model is further configured to generate one or more simulations in response to one or more simulation parameters representative of at least one of maintenance constraints and current conditions experienced on the local roadway, and one or more treatment recommendations to maintain the local roadway, following any one of a user request, a passage of a configurable length of time, or reception of a specific change of input data; and
a touchscreen user interface enabling presentation of output data to a user of the mobile computing platform and input of the one or more simulation parameters entered by the user.

11. The apparatus of claim 10, further comprising a maintenance vehicle interface enabling communication of the maintenance vehicle data from the maintenance vehicle to the mobile computing platform, the maintenance vehicle data at least including data regarding material treatments applied or to be applied, plow usage, and vehicular operation.

12. The apparatus of claim 10, wherein the treatment logic engine includes a plurality of logic components configured to perform mathematical functions that utilize output data from the simulated impact of route-specific weather data on the local roadway to generate the one or more treatment recommendations, the treatment logic engine communicatively coupled to ingest the transportation infrastructure network information that at least includes maintenance policies, localized practices, and road network information relative to maintenance activities to be performed on the local roadway, the road network information including one or more of road construction data, environmental variables, and traffic profiles.

13. The apparatus of claim 10, wherein the route-specific weather data is ingested by communicating queries to at least one weather data server external from the mobile computing platform.

14. The apparatus of claim 10, further comprising, via the touchscreen user interface, enabling a user to view a current condition of the local roadway resulting from the simulated impact of route-specific weather data on the local roadway, and adjust the current condition through a selection of alternate roadway conditions that are representative of real-time observed conditions.

15. The apparatus of claim 10, further comprising, via the touchscreen user interface, enabling a user to select at least one of maintenance configuration information reflecting a desired condition for the local roadway, a timeframe over which the desired condition for the local roadway is to be maintained, the on-vehicle treatment materials to be applied to achieve the desired condition for the local roadway, and the range of application rates of the on-vehicle treatment materials to be applied.

16. The apparatus of claim 15, wherein the at least one of the maintenance configuration information, timeframe, on-vehicle treatment materials to be applied, and the range of application rates are queried from preconfigured profiles available for ingest into the mobile computing platform from a remote server.

17. A method of localized analysis of roadway conditions for managing transportation infrastructure maintenance activities, comprising:
integrating input data representative of weather conditions and maintenance activities for a local roadway into a plurality of data processing functions performed by one or modules in a localized maintenance decision support environment;
modeling a road condition response to the input data representative of weather conditions and maintenance activities on a local roadway, the plurality of data processing functions configured at least to
simulate an impact of route-specific weather data on a local roadway;
evaluate an outcome of the simulated impact of route-specific weather data on the local roadway and apply one or more simulation parameters to revise a simulation of the impact of the route-specific weather data on the local roadway, the one or more simulation parameters being adjustable in response to the outcome of the simulated impact and real-time weather conditions on the local roadway, the one or more simulation parameters including at least one of maintenance constraints and current conditions experienced in real-time on the local roadway,
adjust the simulated impact of route-specific weather data on the local roadway based upon the one or more simulation parameters by performing additional simulations, and
apply transportation infrastructure network information and maintenance vehicle data to the additional simulations of the impact of route-specific weather data on the local roadway;
generating output data that at least includes an identification of one or more treatment recommendations for the local roadway; and
presenting the output data on a user interface to enable a determination of an appropriate maintenance response to the additional simulations and the one or more treatment recommendations.

18. The method of claim 17, wherein the localized maintenance decision support environment is proximate to or within a maintenance vehicle configured to perform or direct a maintenance activity relative to a local roadway.

19. The method of claim 17, wherein the presenting the output data on a user interface further comprises enabling a user to view a current condition of the local roadway resulting from the simulated impact of route-specific weather data on a local roadway, and adjust the current condition through a selection of alternate roadway conditions that are representative of real-time observed conditions,
and
enabling a user to select at least one of maintenance configuration information reflecting a desired condition for the local roadway, a timeframe over which the desired condition for the local roadway is to be maintained, the on-vehicle treatment materials to be applied to achieve the desired condition for the local roadway, and the range of application rates of the on-vehicle treatment materials to be applied.

20. The method of claim 19, further comprising querying at least one of the maintenance configuration information, timeframe, on-vehicle treatment materials to be applied, and the range of application rates from preconfigured profiles available on a remote server.

21. The method of claim 17, wherein the integrating input data representative of weather conditions and maintenance activities on a local roadway further comprises:
ingesting route-specific weather data from at least one external weather data server;
ingesting the one or more simulation parameters from at least one vehicle operator via the user interface;
ingesting the transportation infrastructure network information and the road network information from at least one external agency-specific server, the transportation infrastructure network information including maintenance policies, localized practices, and road network information relative to maintenance activities to be performed on the local roadway, and the road network information including one or more of road construction data, environmental variables, and traffic profiles; and
ingesting the maintenance vehicle data from at least one maintenance vehicle via a maintenance vehicle interface, the maintenance vehicle instructions including data regarding material treatments, plow usage, and vehicular operation.
